(19) United States
(12) Patent Application Publication
(10) Pub. No.: US 2023/0235540 A1
(43) Pub. Date: Jul. 27, 2023

(54) ATMOSPHERIC WATER GENERATOR

(71) Applicant: Rishen JUDDHOO, Durban (ZA)

(72) Inventor: Rishen JUDDHOO, Durban (ZA)

(21) Appl. No.: 17/923,593

(22) PCT Filed: May 5, 2021
(86) PCT No.: PCT/IB2021/053779

§ 371 Date: Nov. 6, 2022

(30) Foreign Application Priority Data
May 5, 2020 (ZA) 2020/02433

(51) Int. Cl. E03B 3/28; B01D 5/00

(52) U.S. Cl. CPC E03B 3/28; B01D 5/0075; B01D 5/009

(57) ABSTRACT

This invention relates, generally, to the collection of water. More specifically, the invention relates to an atmospheric water generator, to a condensation arrangement for an atmospheric water generator, and to a process for extracting water from air. The generator disclosed herein comprises a coolant chilling unit, a condensation arrangement, and a water holding and/or filtration arrangement which cooperate to extract water from air and store and/or filter the same for use.

### FIELD OF THE INVENTION

This invention relates, generally, to the collection of water. More specifically, the invention relates to an atmospheric water generator, to a condensation arrangement for an atmospheric water generator, and to a process for extracting water from air.

### BACKGROUND TO THE INVENTION

Water scarcity is a serious problem in many parts of the world. In fact, it has been found that a significant portion of the global population live under conditions of severe water scarcity during at least some months of the year.

In the context of potable water, scarcity is caused and/or exacerbated by a variety of factors which may increase demand for potable water, such as an increasing population, urbanisation and industrialisation. As a result of these and other factors, the rate of depletion of existing water sources may exceed the rate of replenishment thereof. Furthermore, in the future, it is likely to become even more challenging to supply the potable water requirements of growing populations.

In light of the above, the Inventor has identified a need for a device or system which is capable of supplementing potable water resources, especially in areas suffering from water scarcity.

### SUMMARY OF THE INVENTION

Broadly, in accordance with one aspect of the invention, there is provided an atmospheric water generator which comprises:

a coolant chilling unit which includes a vapour-compression system and a coolant container, wherein an evaporator of the vapour-compression system is positioned in or in proximity to the coolant container such that a coolant in the coolant container is operatively cooled by means of heat exchange between the coolant and a refrigerant circulating through the vapour-compression system;

a condensation arrangement which is in fluid communication with the coolant container, the condensation arrangement defining a condensation chamber which houses at least one condensation surface, wherein the at least one condensation surface is operatively cooled by the coolant, thereby to extract water from air in the condensation chamber by means of condensation on the condensation surface; and

a water holding and/or filtration arrangement which is in fluid communication with the condensation chamber, the water holding and/or filtration arrangement being configured to receive the extracted water from the condensation chamber and to hold and/or filter the extracted water.

In the context of this specification, the “water” extracted in the condensation chamber should be interpreted as water in its liquid state. “Water” in the context of the specification may be understood to be H₂O or a fluid comprising a majority of H₂O which is extracted from air in the condensation chamber in the manner described herein. The term “includes” or “including” may be understood to mean the same as “comprise” or “comprising” and thus these terms are used interchangeably herein.

Moreover, it will be appreciated that the atmospheric water generator may be an apparatus which is configured to extract water from air, for example, ambient air.

The evaporator may be located inside of the coolant container. The coolant container may be sealed. The evaporator may be an evaporator array.

The coolant chamber may be insulated, typically thermally insulated. In this way, fluctuation of temperature of the coolant is minimised. In this regard, the system comprises a volume of coolant matched to a volume of coolant required to cycle through the system.

The coolant may be a liquid substance, e.g. a glycol-water solution, a propylene glycol-water solution, or the like. The coolant may be maintained at a temperature below 0° C. Instead, or in addition, the coolant may be maintained at a temperature between 0° C. and 5° C.

The atmospheric water generator may further include a pump for circulating the coolant in a coolant loop through the coolant container, where it is cooled, through the condensation arrangement, where it becomes warmer as a result of heat exchange with the air, and back through the coolant container for re-cooling.

Differently defined, the coolant circulates within a closed coolant circulation loop or circuit. The refrigerant circulates within a closed refrigerant circulation loop or circuit. The coolant circulation circuit and the refrigerant circulation circuit are insulated from each other physically so that the refrigerant and coolant are kept separate from each other.

The pump may be an inline pump and is thus not located in the coolant container. In this way, no wasteful space within the coolant container is required as opposed to a submersible pump being used. However, it will be understood that a submersible pump in the coolant chamber may also be used to move the coolant through the coolant circuit, in some example embodiments.

The at least one condensation surface may be defined by at least one condensation plate. The plate may be substantially disc-shaped. The plate may define internal flow paths through which the coolant operatively flows to cool the condensation surface(s).

The condensation plate may define an internally disposed closed circuit flow path for coolant between an entry point or inlet and an outlet point or outlet of the plate. The flow path defined by the plate may be a spiral flow path from the inlet to the outlet. The plate may define an internal groove which defines the flow path for coolant through the plate. It will be appreciated that the flow path through the plate forms part of the coolant circuit described herein.

The plate may be formed by a pair of layers bonded together, wherein one or both of the layers defines all or a path of the groove adjacent an operative bonding surface. The operative bonding surface may be the surface where the layers are bonded together to form the plate.

The condensation surface may be non-smooth/rough/textured in a predetermined manner so as to increase the rate of condensation. The predetermined manner in which the non-smooth/rough/textured condensation surface is provided may be a regular textured pattern/roughness pattern, or the like. In this way, a more uniform condensation outcome may be achieved on multiple condensation plates. The condensation surface may comprise a plurality of pits therein and/or bumps thereon thereby to provide the roughness or non-smoothness contemplated herein. The pits may be nano-pits of nanometre diameter and/or radius.

In some embodiments, the condensation chamber houses a condensation plate assembly which includes a plurality of vertically spaced apart condensation plates. The condensation arrangement may further include a discharge manifold and a suction manifold. The discharge manifold may include a primary single pipe structure, in fluid communication with the coolant container, which is configured to receive the coolant from the coolant container and which defines multiple branches of secondary pipelines configured to distribute the coolant into the respective condensation plates. The suction manifold may include multiple branches of primary pipelines, in fluid communication with internal flow paths of respective condensation plates, merging into a single secondary pipe structure, which in turn operatively delivers the coolant back to the coolant container.

The condensation arrangement may further include at least one fan for producing air flow in the condensation chamber. The at least one fan may be configured to produce air flow in a direction substantially parallel to the at least one condensation surface. In a preferred example embodiment, the condensation arrangement may comprise multiple fans and/or a blower with multiple entry points into the condensation chamber. The fan/s may be positive pressure fans. The fan/s may increase the volume of air travelling through the system. The fans may be controlled by pulse-width modulation (PWM) control.

The condensation chamber may be defined by an enclosure, e.g. a sheet metal enclosure. The enclosure may include at least one vent which is positioned so as operatively to increase internal static pressure in the condensation chamber. The at least one vent may be configured to ensure that a volumetric flow rate of air entering the condensation chamber is greater than a volumetric flow rate of air egressing the condensation chamber. It will be appreciated that increasing the pressure in the chamber may increase the chances of nucleation of water droplets on the disc surface.

The enclosure may include an opening, e.g. in its bottom, for delivering the extracted water, e.g. for gravity feeding the water, to the water holding and/or filtration arrangement.

The condensation arrangement may further include an electrostatic filter configured such that the at least one fan draws air into the condensation chamber via the electrostatic filter.

As described above, the at least one condensation surface may be provided with surface roughness, texturing and/or deformations. For instance, the condensation surface may be engraved with pit formations.

The condensation arrangement may further include a mechanical extractor to extract the water which has condensed on the at least one condensation surface. In this regard, the condensation arrangement may comprise at least one wiper arm which is configured to sweep or be dragged across the at least one condensation surface, thereby facilitating collection of condensation from the condensation surface.

The wiper arm/s may be configured to sweep or be dragged across the at least one condensation surface at predetermined time intervals to allow water droplets to condense on the at least one condensation surface. The predetermined time intervals may be temporally spaced to allow sufficient time for condensation water droplets to grow or condense on the condensation surface from nucleation to maturity. The predetermined time intervals may be selected based on a five parameter logistic (5PL) asymmetrical sigmoidal model. This is because the condensation or growth in size of water droplets from nucleation to maturity over a period of time follows a 5PL asymmetrical sigmoidal model, i.e., over a period of time from nucleation of a water droplet(s) at a site, there is an exponential growth of the size, particularly the radius, of the water droplet until a point of inflection occurs when the droplet(s) begin to coalesce and decrease growing. It follows that wherein the wiper arm may be configured to sweep or be dragged across the at least one condensation surface when the model indicates that the droplet has reached or close to reach its maximum size/diameter/radius. The 5PL asymmetrical sigmoidal model may be described by the following equation:

$$F ( y ) = a + \frac{( d - a )}{{( 1 + {( \frac{x}{c} )}^{b} )}^{f}} ,$$

wherein:

X: is the expected vapour concentration;
a: minimum radius asymptote of a droplet;
d: critical radius asymptote of a droplet;
b: slope parameter;
c: point of inflection; and
f: asymmetry parameter.

The condensation arrangement may include a rotatable shaft which is configured to rotate the wiper arm about or along the condensation surface. The arrangement may comprise a plurality of wiper arms, wherein each wiper arm is configured to sweep or be dragged across one or more condensation surface(s). in one example embodiment, a wiper arm may be interposed between an adjacent pair of plates such that the plates sandwich the wiper arm, wherein actuation of the wiper arm causes the same to sweep or be dragger across the condensation surfaces of the pair of plates.

It will be understood that the radius of the condensation plates and/or the number of condensation plates, etc. are dependent on the amount of water required to be produced by the generator (by controlling the condensation surface area). It follows that in one example embodiment, the condensation plates may be modular so that additional plates may be added or excess plates may be removed from the condensation chamber depending on the amount of water to be produced.

The water holding and/or filtration arrangement may include a temporary holding tank which is configured to receive water from the condensation chamber, a consumption holding tank in fluid communication with the temporary holding tank and a filter arrangement disposed between the temporary holding tank and the consumption holding tank for filtering and/or decontaminating the extracted water.

A filter such as a coarse granule activated carbon filter may be disposed between the condensation chamber and the temporary holding tank. An ozone generator may be configured to introduce ozone into the temporary holding tank for sterilisation purposes.

The filter arrangement located between the temporary holding tank and the consumption holding tank may include one or more of the following: a reverse osmosis membrane, a fine granulated activated carbon filter, a mineral filter, an ultra-violet disinfection device and an advanced oxidation process (AOP) machine.

The consumption holding tank may be provided with a coolant coil arrangement for cooling the water therein using the same coolant used to cool the condensation surface(s). In other words, in some embodiments, the atmospheric water generator may be configured to circulate the coolant through the condensation arrangement for cooling the condensation surface(s) and through the consumption holding tank for cooling the water therein.

The holding and filtration arrangement may further include a return pump and a return pipeline for returning water from the consumption holding tank to the temporary holding tank for re-filtration.

Broadly, in accordance with another aspect of the invention, there is provided a condensation arrangement for an atmospheric water generator, the condensation arrangement defining a condensation chamber which houses at least one condensation surface, wherein the at least one condensation surface is operatively cooled by a coolant circulated through the condensation chamber, thereby to extract water from air in the condensation chamber by means of condensation on the condensation surface, wherein the coolant is cooled by a vapour-compression system outside of the condensation chamber.

Broadly, in accordance with a further aspect of the invention, there is provided a process for extracting water from air, the process comprising:

cooling a coolant by means of heat exchange between the coolant and a refrigerant circulating through a vapour-compression system; and

using the coolant to cool at least one condensation surface housed in a condensation chamber external to the vapour-compression system, thereby to extract water from air in the condensation chamber by means of condensation on the condensation surface.

The process may include storing and/or filtering the extracted water in a water holding and/or filtration arrangement.

The process may further include using the coolant to cool the extracted water held in the water holding and/or filtration arrangement.

### BRIEF DESCRIPTION OF THE DRAWINGS

FIG. 1 is a schematic diagram showing an embodiment of an atmospheric water generator according to the invention, wherein the diagram also shows flow paths of a refrigerant, a coolant and liquid water so as to illustrate the atmospheric water generator in use;

FIG. 2 is a three-dimensional view, substantially from the top, of parts of a condensation arrangement of the atmospheric water generator of FIG. 1;

FIG. 3 is another three-dimensional view, substantially from the bottom, of the parts of the condensation arrangement of FIG. 2;

FIG. 4 is a three-dimensional view of a condensation plate assembly which is contained in a condensation chamber of the atmospheric water generator of FIG. 1;

FIG. 5 is a top view of the condensation plate assembly of FIG. 4;

FIG. 6 is a side view of the condensation plate assembly of FIG. 4;

FIG. 7 is a three-dimensional view of a condensation plate of the condensation plate assembly of FIG. 4;

FIG. 8 is a bottom view of a first layer of the condensation plate of FIG. 7, illustrating a continuous groove in a surface of the first layer;

FIG. 9 is a top view of a second layer of the condensation plate of FIG. 7, illustrating a continuous groove in a surface of the second layer;

FIG. 10 is a three-dimensional view, including hidden detail, of a transition connector employed in the condensation plate assembly of FIG. 4;

FIG. 11 is a top view of another example embodiment of a condensation plate in accordance with an example embodiment of the invention;

FIG. 12 is a bottom view of a first layer of the condensation plate of FIG. 11, illustrating a continuous groove in a surface of the first layer, wherein the top view of a second layer is substantially a mirror thereof; and

FIG. 13 is a three-dimensional view of the first layer of the condensation plate of FIG. 11.

### DETAILED DESCRIPTION WITH REFERENCE TO THE DRAWINGS

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible, and may even be desirable in certain circumstances, and are a part of the present invention. Thus, the following description is provided as illustrative of the principles of the present invention and not a limitation thereof.

It will be appreciated that the phrase “for example,” “such as”, and variants thereof describe non-limiting embodiments of the presently disclosed subject matter.

Reference in the specification to “one example embodiment”, “another example embodiment”, “some example embodiment”, or variants thereof means that a particular feature, structure or characteristic described in connection with the embodiment(s) is included in at least one embodiment of the presently disclosed subject matter. Thus, the use of the phrase “one example embodiment”, “another example embodiment”, “some example embodiments”, or variants thereof does not necessarily refer to the same embodiment(s).

Unless otherwise stated, some features of the subject matter described herein, which are, described in the context of separate embodiments for purposes of clarity, may also be provided in combination in a single embodiment. Similarly, various features of the subject matter disclosed herein which are described in the context of a single embodiment may also be provided separately or in any suitable sub-combination.

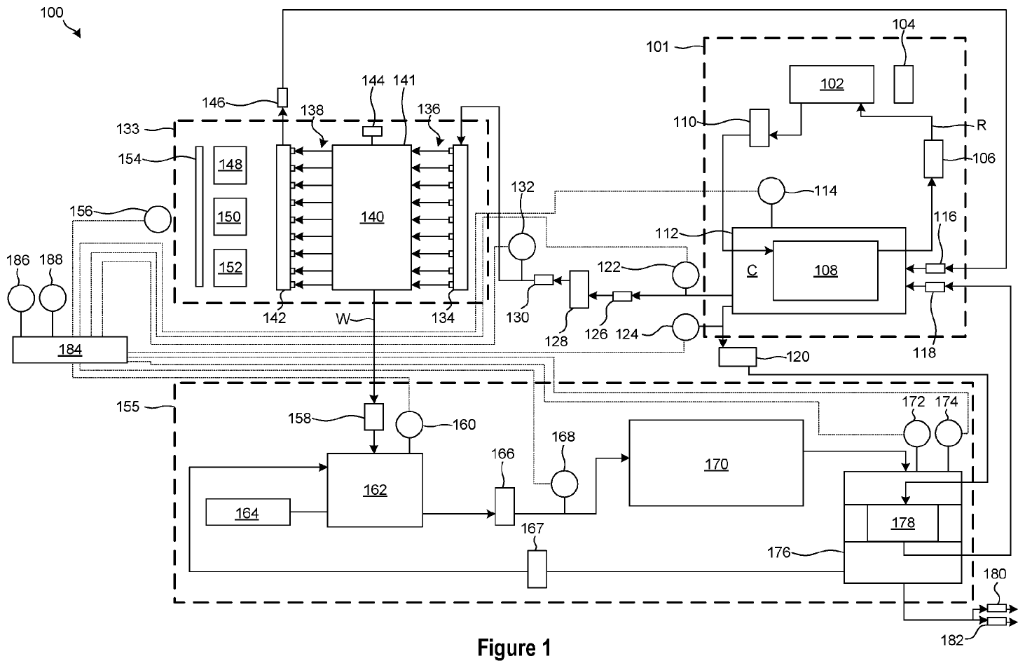

FIG. 1 schematically illustrates an example embodiment of an atmospheric water generator (hereinafter referred to as “the generator 100”) according to the invention. The generator 100 includes three primary components: a coolant chilling unit 101, a condensation arrangement 133 and a water holding and filtration arrangement 155. The generator 100 also includes a microprocessor 184 which monitors and/or controls certain components of the generator 100 (as conceptually shown by the broken lines in FIG. 1).

In this example embodiment, the generator 100 is configured to cool a liquid coolant substance by way of a vapour-compression refrigeration process in the coolant chilling unit 101, to use the coolant to facilitate condensation of water from air in the condensation arrangement 133, and to store and filter the water formed in the condensation arrangement 133 in the holding and filtration arrangement 155. Furthermore, the generator 100 is configured to pump the coolant through the extracted water to cool it down for consumption purposes.

The coolant chilling unit 101 includes the basic parts associated with a vapour-compression system: a condenser array 102 served by an external fan 104, a compressor 106, an evaporator array 108 and an expansion valve 110. In use, a refrigerant “R” is circulated in a closed loop, particularly a closed refrigerant loop or circuit, through the components 102, 106, 108 and 110, as will be well understood by those of ordinary skill in the art.

In this example embodiment, the evaporator array 108 of the vapour-compression system is contained in a sealed coolant container, or coolant tank 112, which forms part of the coolant chilling unit 101.

The coolant tank 112 contains a liquid coolant “C” which is circulated through a closed coolant loop or circuit in the form of a closed pipeline system which is separate from the refrigerant loop or circuit or the vapour-compression system, as will be described in detail below. In this example, a propylene glycol-water solution of concentration 25% is used as the coolant. It will be understood that the concentration of the propylene glycol-water solution may be dependent on the set temperature and may thus change in other example embodiments. Other suitable coolants may be employed in alternative embodiments of the invention.

A temperature sensor 114 is coupled to the coolant tank 112. The temperature sensor 114 provides feedback to the microprocessor 184. In this example, the temperature in the coolant tank 112 is intended to remain between 0° C. and 5° C. or at a predefined set-point within this range. In some example embodiments, the temperature may be set below 0° C. The lower temperature of the coolant C may be to mitigate heat loss in the system.

In basic terms, the compressor 106 is configured to increase the pressure and temperature of the refrigerant R such that it becomes a superheated vapour. The condenser array 102 acts as a heat exchanger which, with the aid of external cooling provided by the fan 104, cools the refrigerant R to a saturated/subcooled liquid. The expansion valve 110 is configured such that, when the liquid refrigerant R passes through it, the refrigerant R undergoes a decrease in pressure that changes the phase state of the refrigerant R from liquid to vapour (or a liquid/vapour mixture). The evaporator array 108 operatively acts as a heat exchanger between the coolant C in the coolant tank 112 and the refrigerant R circulating through the vapour-compression system. Heat from the coolant C is transferred to the refrigerant R at the evaporator array 108, cooling/chilling the coolant C and turning the refrigerant R into a lower pressure vapour (than prior to entering the evaporator array 108). From the evaporator array 108, the vapour refrigerant R travels to the compressor 106 and the above process repeats itself.

It should be noted that the refrigerant “R” and the coolant “C” are physically separated from each other at all times during the process, each circulating in a separate, closed loop/system, such that the refrigerant R and coolant C never physically mix.

As alluded to above, the coolant C which is chilled by the coolant chilling unit 101 is used as the primary cooling means in the condensation arrangement 133 for the formation of liquid water out of air. A centrifugal pump 128 is provided for delivering chilled coolant from the coolant tank 112 to the condensation arrangement 133 and to ensure that it is circulated back to the coolant tank 112 once it has passed through the condensation arrangement 133 (to be re-cooled).

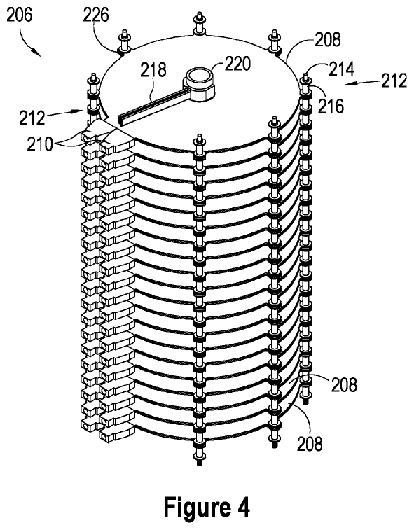

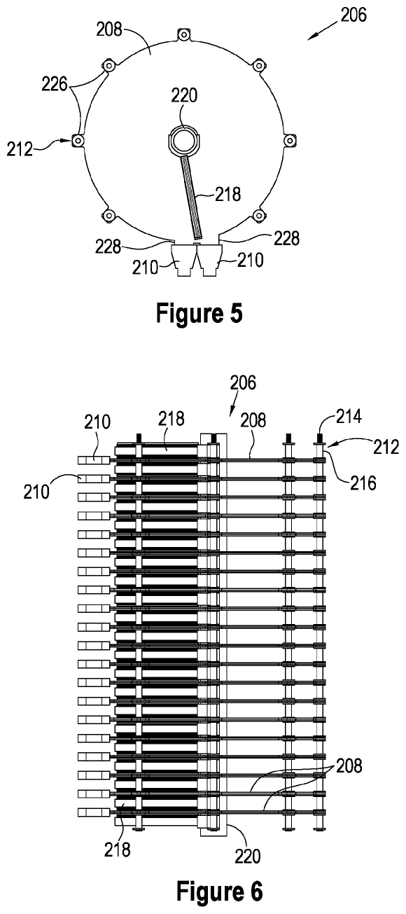

The condensation arrangement 133 includes a discharge manifold, a condensation chamber 140 and a suction manifold. The discharge manifold includes primary single pipe structure 134 that receives the coolant C from the coolant tank 112 and defines multiple branches 136 of secondary pipelines that distribute the coolant C into individual condensation plates 208 (see FIGS. 4 to 9) in the condensation chamber 140. The suction manifold consists of multiple branches 138 of primary pipelines merging into a single secondary pipe structure 142, which in turn delivers the coolant C back to the coolant tank 112. Pipes of the discharge manifold and suction manifold are insulated such that heat transfer occurs substantially only in the condensation chamber 140, wherein the coolant C is required to cool the plates 208.

The Inventor has found that it may be advantageous to pump the coolant at specific non-dimensional velocities through the primary/single pipes and the multiple branched pipelines, respectively. Specifically, the Inventor has found that a Reynolds number ranging from about 6000 to 9000 may be considered for the single pipes while a Reynolds number ranging from about 2000 to 4000 may be considered for the branched pipelines.

It will be appreciated that the coolant C is pumped with a specified velocity considering a Reynolds number of laminar flow. In other words, the Reynolds number is in the Laminar range. In this way, the coolant C is distributed into individual pipelines which will flow to the condensation chamber 140 with a specified velocity considering a Reynolds number range between transition—turbulent.

The condensation arrangement 133 further includes a plurality of fans 148, 150, 152 for producing or providing air flow in the condensation chamber 140 and an electrostatic filter 154 which is provided as a mechanical, first phase filter attached or attachable to inlets of the fans 148, 150, 152 to aid in the removal of airborne particles.

Additionally, the condensation arrangement 133 includes a geared motor 144 mounted to an enclosure 141 of the condensation chamber 140 (described in greater detail below).

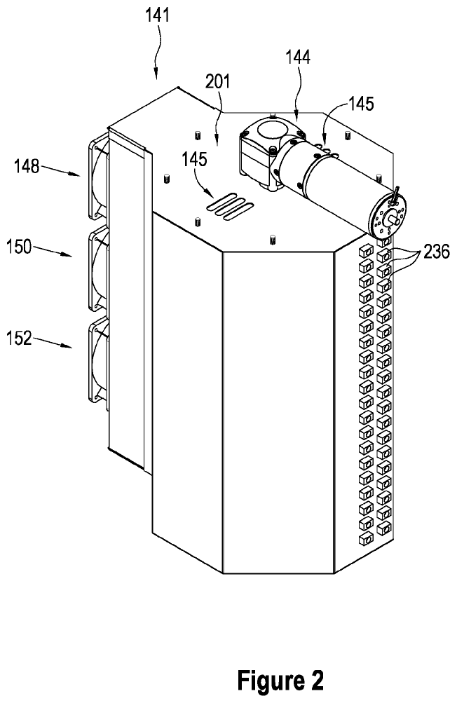

The purpose of the condensation chamber 140 is the extraction of liquid water out of the air which is operatively urged into the chamber 140 by the fans 148, 150, 152. The structure and functioning of the condensation chamber 140 and other components of the condensation arrangement 133 will now be described with reference to FIGS. 2 to 10.

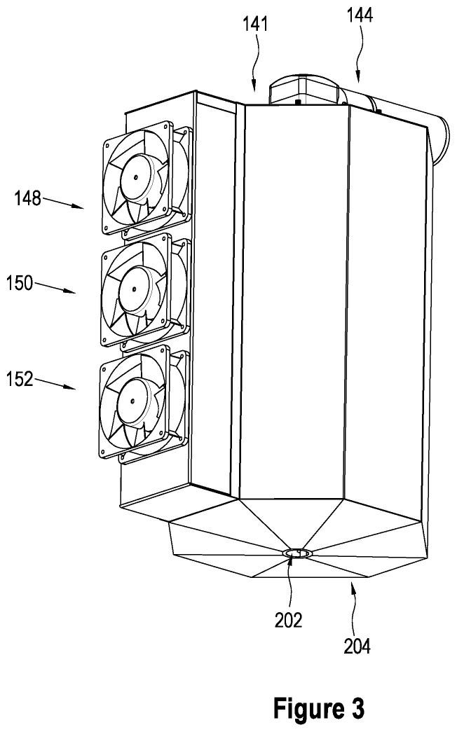

As shown in FIGS. 2 and 3, the condensation chamber 140 is defined by a substantially octagonal sheet metal enclosure 141, with a flat top 201 and a flat bottom 204.

The fans 148, 150, 152 are externally attached to a rear of the enclosure 141 and the motor 144 is externally mounted to the top 201 of the enclosure 141. The electrostatic filter (not shown in FIGS. 2 and 3) is intended to be mounted such that air is drawn in via the filter.

The fans 148, 150, 152 are mounted in a vertically spaced apart manner and are configured to produce a specific rate of air flow in the chamber 140, which can be selected based on factors such as atmospheric humidity and temperature and/or rate or volume of condensation required.

The enclosure 141 defining the condensation chamber 140 is further provided with outlet vents 145 positioned at the top 201 of the enclosure 141, on opposite sides of the motor 144. The vents 145 are specifically positioned so as to increase the internal static pressure produced by the fans 148, 150, 152 during operation of the generator 100.

The enclosure 141 is provided with a circular opening 202 in its bottom 204, which is in fluid communication with the chamber 140, and via which water “W” extracted from the air inside the chamber 140 operatively egresses the chamber 140 and travels to the holding and filtration arrangement 155.

The chamber 140 (i.e. the space inside the enclosure 141) contains a condensation plate assembly 206, which is illustrated in FIGS. 4 to 6. The condensation plate assembly 206 consists of a plurality of vertically stacked and spaced apart condensation plates 208. The plates 208 are substantially disc-shaped and extend horizontally inside the chamber 140, i.e. transverse to a length of the enclosure 141.

It should be noted that the radius and number of plates 208 used in a condensation plate assembly 206 according to the invention may vary, depending on the amount/rate of water to be produced.

The plates 208 are spaced apart by vertical interlocking screw arrangements 212 which are provided in a circumferentially spaced apart manner about edges of the assembly 206. Each individual screw arrangement 212 includes an externally threaded solid shaft 214 and a complemental internally threaded hollow shaft 216, as is best shown in FIG. 4. The individual screw arrangements 212 are vertically stacked to provide the required spacing between the plates 208, best shown in FIG. 6. In this example embodiment, seven vertical stacks of screw arrangements 212 are circumferentially provided about the assembly 206.

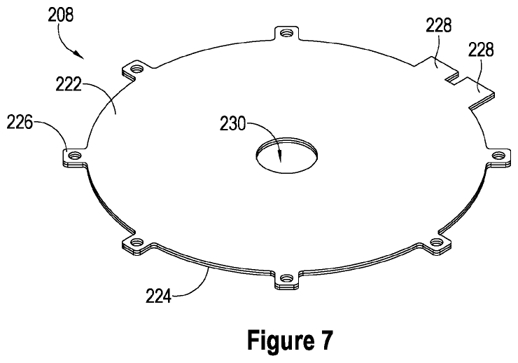

Turning in particular to FIGS. 7 to 9, each plate 208 is defined by two substantially planar, disc-shaped metal layers 222 and 224 which are positioned directly on top of each other. The layers 222, 224 are substantially circular and have central, circular openings defining a central opening 230 in the plate 208.

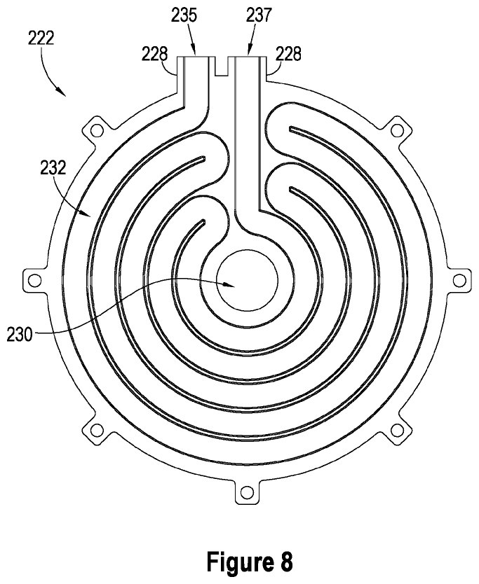

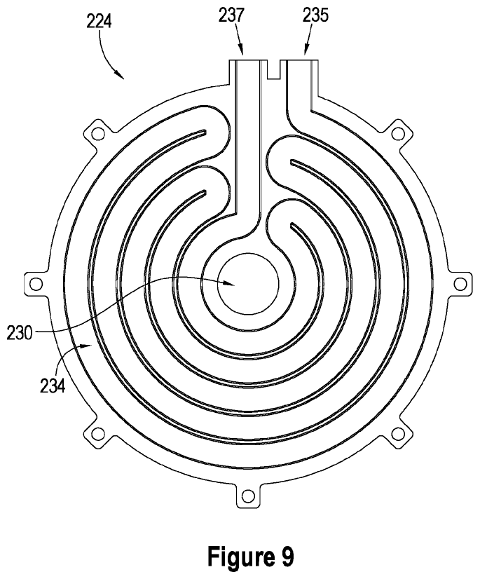

In this example, the layers 222, 224 have each been milled with a continuous groove 232, 234 in one major surface thereof (see FIGS. 8 and 9). Each groove 232, 234 follows a spiral path along the particular surface of the layer 222, 224, from a single entry point, or inlet 235, to a single exit point, or outlet 237. The grooves 232, 234 mirror each other such that when the layers 222, 224 are mounted to each other with their grooved surfaces facing each other (thus defining the plate 208), the grooves 232, 234 are aligned to define a coolant flow path, between the inlet 235 and the outlet 237, inside of the plate 208.

The other major surface of each layer 222, 224 is substantially smooth (but for the texturing which is referred to below). In other words, the top and bottom surfaces of the plate 208 are not grooved as shown in FIGS. 8 and 9.

Each plate 208 further defines a series of circumferentially spaced apart flanges 226 with holes therein for receiving the interlocking screw arrangements 212 referred to above.

The inlet 235 and outlet 237 described above are respectively defined at adjacent connecting flanges 228 which provide for the connection of transition connectors 210 to the plate 208. Two transition connectors 210 are connected to each plate 208, as shown in FIG. 4. One of these connectors 210 operatively provides fluid communication between the inlet of the plate 208 and one of the branches 136 of the discharge manifold (for receiving coolant from the coolant tank 112 via the pipe 134), while the other connector 210 operatively provides fluid communication between the outlet of the plate 208 and one of the branches 138 of the suction manifold (for returning warmer coolant to the coolant tank 112 for re-cooling via the pipe 142).

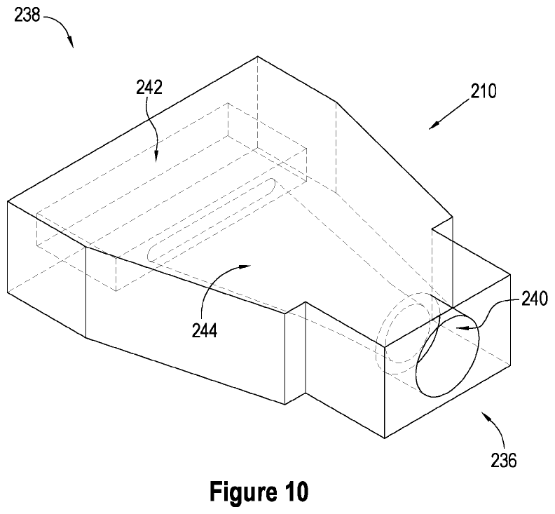

As shown in FIG. 10, the transition connector 210 defines a circular opening 240 at a first end 236 thereof and a rectangular opening 242 at a second end 238 thereof, with a transition channel 244 extending internally there between, along a length of the connector 210. In this way, the connector 210 allows the pipes 134, 142, which have circular cross-sections, to be connected to the inlets and outlets of the flow paths defined by the grooves of the plate 208, which have rectangular cross-sections.

In order to produce each plate 208, the layers 222, 224 may be fused together by means of diffusion bonding at a high temperature and pressure, thus forming a single plate with substantially the same mechanical properties.

The substantially smooth top and bottom surfaces (i.e. the condensation surfaces) of each plate 208 may be engraved with pits in a specific orientation or distribution to facilitate nucleation points for condensation. The Inventor has found that droplet nucleation may be improved when employing surface roughness/texture/deformations on the outer surfaces of the plates 208. Differently stated, the outer surfaces of the plates 208 may be non-smooth thereby to facilitate improved condensation.

The condensation plate assembly 206 further includes a plurality of wiper arms 218 for facilitating collection of condensation from the surfaces of the plates 208, in use. More specifically, a wiper arm 218 is provided on top of and extends parallel to each plate 208 such that each wiper arm 218 abuts an outer surface of the relevant plate 208, as is shown in FIG. 6. The wiper arms 218 located between two plates 208 are shaped and dimensioned so as to abut both plates 208 adjacent thereto.

The wiper arms 218 have a length substantially equal to a radius of the plates 208 and are connected to a central, hollow, rotatable shaft 220 which fits into and extends through the central openings 230 of the plates 208 in the assembly 206. The shaft 220 is rotatably coupled to the motor 144.

In this example, the diameter of the shaft 220 is less than the diameter of the opening 230. This allows pairs of adjacent wiper arms 218 to be connected to each other on opposite sides of a plate 208, e.g. by a rigid polymer structure extending through the opening 230 (through the gap between the shaft 220 and inner edges of the plate 208).

In use, the shaft 220 is rotated by the motor 144, e.g. via a transmission coupling and bearing, which in turn causes rotation of the wiper arms 218 about a longitudinal axis of the assembly 206. The wiper arms 218 are configured such that they sweep across the outer surfaces of the plates 206 while rotating.

During operation of the generator 100, the coolant “C”, which has been cooled at the coolant chilling unit 101, travels through the discharge manifold and into the spiral grooves, or internal flow paths, of individual plates 208 of the condensation plate assembly 206. The coolant C cools the plates 208 approximately to the temperature of the coolant C. The process is configured such that this temperature is below the dew point temperature of condensation. At the same time, the fans 148, 150, 152 draw/urge air (via the electrostatic filter 154) across the outer surfaces of the plates 208. The direction of airflow is preferably substantially parallel to the surfaces of the plates 208.

Moisture in the air in the chamber 140 will then be converted to a liquid water state as a result of a temperature drop. In other words, the kinetic energy associated with water molecules in the air will be lowered to precipitate a phase change from gas to liquid, causing condensation to occur and water “W” to form externally on the outer surfaces plates 208. The outer surfaces of the plates 208 thus act as “condensation surfaces” on which water droplets are formed.

To increase the pressure within the chamber 140, the chamber's outlets/vents may be configured to restrict air from leaving the chamber 140 such that the volumetric flow rate entering the chamber 140 is greater than the volumetric flow rate leaving the chamber 140. In use, the wiper arms 218 are dragged across substantially the entire outer surface area of each plate 208 as a result of rotation of the shaft 220. The rotational rate of the shaft 220 may be selected/adjusted based on factors such as the volumetric growth rate to a predetermined critical radius of the condensation occurring on the surfaces of the plates 208. The wiper arms 218 distribute collected condensation along the lengths of the arms 218, from an inner area of each plate 208 to its outer edge, from where the water falls to a collecting funnel (not shown) near the bottom 204 of the enclosure 141.

As a result of heat exchange occurring inside the chamber 140, the coolant egressing the chamber 140 will have a higher temperature than the coolant entering the chamber 140. The higher temperature coolant leaving each plate 208 flows through the suction manifold and is then returned to the cooling tank 112 for re-cooling, after which it can again be circulated to the plates 208, thus forming a closed loop system.

The water formed in the chamber 140 is gravity fed to the holding and filtration arrangement 155, which makes use of several techniques to remove solids and/or contaminants from the water harvested in the condensation chamber 140. A flow control valve (not shown) may be positioned at the bottom 204 of the chamber 140 for controlling the flow of water into the holding and filtration arrangement 155.

Referring again to FIG. 1, the holding and filtration arrangement 155 includes a coarse granule activated carbon filter 158, a temporary holding tank 162, an ozone generator 164, a solenoid pump or filtration pump 166, a secondary filter arrangement 170 and a consumption holding tank 176.

In this example embodiment, the water “W” is first fed through the activated carbon filter 158. The filter 158 consists of granular carbon that is highly porous and provides a first stage of physical filtration. Once the water has travelled through the filter 158, it goes into the temporary holding tank 162. The ozone generator 164 produces O³ which is introduced into the tank 162 for sterilisation purposes.

The water collects to a set level in the tank 162, after which it is pumped through the secondary filter arrangement 170 by the pump 166. The secondary filter arrangement 170 may consist of components such as a reverse osmosis membrane, fine granulated activated carbon filter, mineral filter and ultra-violet disinfection device (e.g. ultra-violet light tube(s)). The filter arrangement 170 may also include an advanced oxidation process (AOP) machine.

A reverse osmosis filter is intended to provide physical filtration by way of a membrane. Water is essentially forced through the membrane to draw out small pollutants. A fine granulated activated carbon filter is similar to the filter 158, but the granular carbon is much finer. Mineral filtration may involve adding salt-based mineral deposits to the water, e.g. to compensate for the removal of salts as a result of other filtration techniques. An AOP machine uses a combination of O³ and ultra-violet radiation to form a chemical reaction of the O³ to short-lived hydroxyl radicals. These radicals may interact with the water in a tube before or after other filtration.

The water is then stored in the consumption holding tank 176. Potable water can be obtained from the tank 176, e.g. for human consumption.

In this example, the holding tank 176 is provided with a coolant coil arrangement 178 for cooling the water therein using the same coolant “C” referred to above. As shown in FIG. 1, the coolant, after having been chilled in the coolant chilling unit 101, is not only circulated through the condensation arrangement 133, but is also circulated through the holding tank 176 by a way of a solenoid pump 120. Water temperature in the tank 176 is monitored by a temperature sensor 172 which sends feedback to the microprocessor 184.

In addition to the above, the holding and filtration arrangement 155 may include a return pump 167 and a return pipeline for returning water from the holding tank 176 to the holding tank 162 for re-filtration, as shown in FIG. 1.

Check valves are provided in appropriate positions to prevent backward flow in the generator 100. Specifically, in the example embodiment of FIG. 1:
check valve 146 is provided where warmer coolant egresses the condensation arrangement 133;
check valves 116, 118 are provided where the warmer coolant enters back into the coolant tank 112 from the pipe 142 and from the coil or heat exchanger 178;
check valves 126 and 130 are provided where the chilled coolant egresses the coolant tank 112 and enters the condensation arrangement 133, respectively; and
check valves 180, 182 are provided at two generator outlets (essentially “taps”) of the generator 100, as shown in the bottom right hand corner of FIG. 1.

The generator 100 is provided with several switches, or sensors, all of which are configured to provide feedback to the microprocessor 184. Flow switches 122 and 124 are provided at the two outlets of the coolant tank 112, i.e. the outlet to the condensation arrangement 133 and the outlet to the tank 176. A further flow switch 156 is located near the electrostatic filter 154. A first pressure switch 132 is provided along the coolant pipe before the condensation arrangement 133 and a second pressure switch 168 is provided along the water pipe before the filter arrangement 170. A first level switch 160 monitors the water level in the tank 162 and a second level switch 174 monitors the water level in the tank 176.

The microprocessor 184 also receives an indication of the atmospheric humidity via a humidity sensor 186 coupled thereto, and an indication of the ambient temperature via a temperature sensor 188 coupled thereto.

As an example, in use, the generator 100 may be controlled/operated in the following manner, using the components described with reference to FIG. 1:
A) The generator 100 commences operation to extract water, in a liquid state, from air in the chamber 140.
B) The compressor 106 is switched on, circulating the refrigerant “R” in the vapour-compression components of the coolant chilling unit 101. The fan 104 associated with the condenser array 102 is also switched on.
C) External humidity and temperature readings taken using the sensors 186 and 188. Based on these readings and/or other factors or requirements, a set-point for the speed of the condensation chamber fans 148, 150, 152 is then established.
D) Feedback from the temperature sensor 114 is checked to determine whether a temperature set-point for the coolant tank 112 has been reached:
   I) If “no”, the compressor 106 remains on.
   II) If “yes”, the compressor is switched off, the pump 128 is switched on and a time delay for the fans 148, 150, 152 is activated.
E) Closed loop temperature set-point checking in the coolant tank 112:
   I) If the temperature is above the set-point, then the compressor 106 is switched back on.
   II) Else, then compressor 106 remains off.
F) The time delay for the fans 148, 150, 152 elapses and they are switched on. A time delay for the motor 144 is activated.
G) The time delay for the motor 144 elapses and it is switched on.
H) The motor 144 operates in accordance with a specific rotational rate, speed and/or frequency.
I) Water “W” begins to accumulate in the temporary holding tank 162.
J) The level sensor 160 is used to check whether a certain level (“high level”) has been reached in the tank 162:
   I) If “yes”, the pumps 166 and 120 are switched on and the condensation chamber fans 148, 150, 152 are switched off.
   II) If “no”, no action is taken.
K) Water begins to accumulate in the consumption holding tank 176.
L) Level sensor 160 is used to check whether a certain level (“low level”) has been reached in the tank 162:
   I) If “yes”, the pump 166 is switched off and the fans 148, 150, 152 are switched back on.
   II) If “no”, no action is taken.
M) Level sensor 174 is used to check whether a certain level (“high level”) has been reached in the tank 176:
   I) If “yes”, the pump 166 is switched off.
   II) If “no”, no action is taken.
N) Level sensor 174 is used to check whether a certain level (“low level”) has been reached in the tank 176:
   I) If “yes”, the pump 166 is switched on.
   II) If “no”, no action is taken.
O) Feedback from the temperature sensor 172 is checked to determine whether a temperature set-point for the tank 176 has been reached:
   I) If the temperature set-point is reached, then the pump 120 is switched off.
   II) Else, then pump 120 remains on.
P) Interaction of sensors to perform an “override”:
   I) If both the tanks 162 and 176 are at their “high level”, a partial shutdown of equipment activates:
      i) The pump 128 is switched off.
      ii) The motor 144 is switched off.
      iii) The fans 148, 150, 152 are switched off.
      iv) A recycle line valve opens and tap valve closes.
      v) The pump 166 remains on.
      vi) The pump 120 remains on.

II) Else, no action is taken.
Q) Override of supply of water function:
   I) If “override” function activates, then flow to consumption tank 176 is closed, water flows through external tap and the pump 120 is switched off.

It will be understood that the components of the generator 100 can be powered by any suitable power source, e.g. a mains power supply may supply power to the fans 104, 148, 150, 152, the electrostatic filter 154, the motor 144, the compressor 106, the pumps 120, 128, 166 and the ozone generator 164, and/or to other components requiring electrical power.

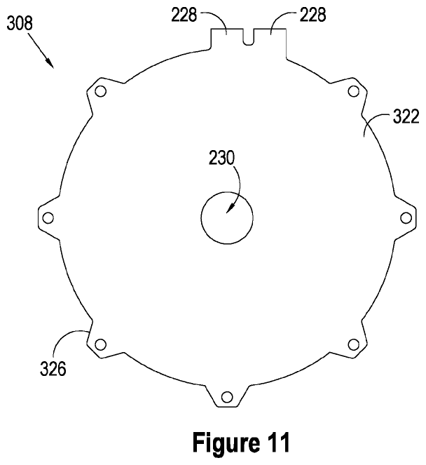

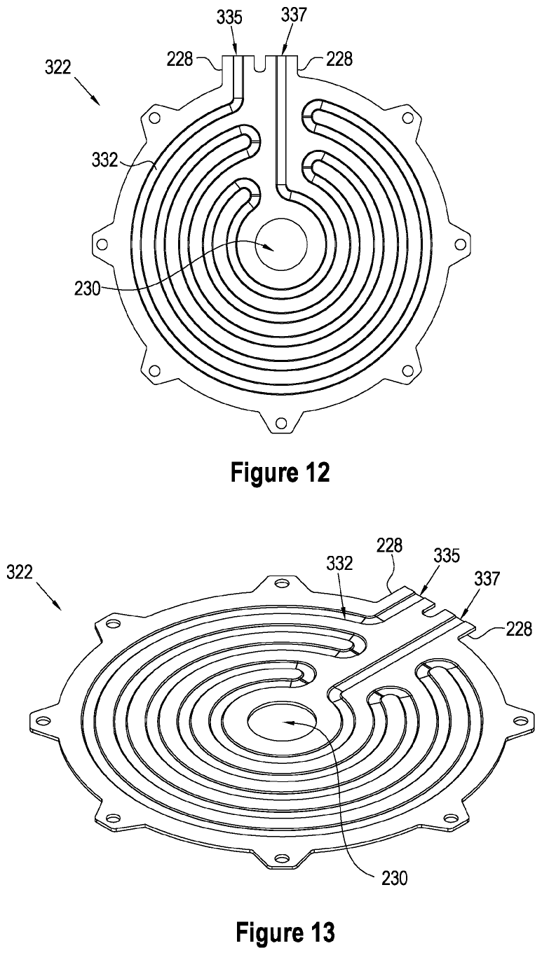

Referring to FIG. 11 of the drawings, another example embodiment of a condensation plate, in accordance with the invention disclosed herein, is generally indicated by reference numeral 308 (FIG. 11). The plate 308 is substantially similar to the plate 208 described above and thus similar reference numerals are used to indicate like parts, wherein the foregoing comments in respect of the plate 208 and similarly labelled parts apply mutatis mutandis. The plate 308 differs from the plate 208 in that the layers thereof have a deeper groove and the flanges 326 are differently shaped. FIGS. 12 and 13 show only a first layer 322 of the plate 308, with the second layer not illustrated. Those skilled in the art will appreciate that the second layer may be a mirror of the first layer 322. In any event, the first layer 322 defines a narrower and optionally deeper groove 332 than the groove 232 of the first later 222 of the plate 208 extending between the inlet 335 and outlet 337 of the first layer 322. In this way, the plate 308, provides a narrower and deeper groove than the groove of the plate 208.

Embodiments of the present invention provide an atmospheric water generator, a condensation arrangement for an atmospheric water generator and a process for extracting liquid water from air.

The atmospheric water generator as described herein may be capable of supplementing potable water resources, especially by providing it as a self-contained unit for use in areas suffering from water scarcity.

The Inventor understands that around 13×10¹² m³ of water vapour is present within the Earth's atmosphere at any given moment. The generator described herein can utilise this resource to extract water from humid air and to process the extracted water into a potable state.

1. An atmospheric water generator which comprises:
a coolant chilling unit which includes a vapour-compression system and a coolant container, wherein an evaporator of the vapour-compression system is positioned in or in proximity to the coolant container such that a coolant in the coolant container is operatively cooled by means of heat exchange between the coolant and a refrigerant circulating through the vapour-compression system;
a condensation arrangement which is in fluid communication with the coolant container, the condensation arrangement defining a condensation chamber which houses at least one condensation surface, wherein the at least one condensation surface is operatively cooled by the coolant, thereby to extract water from air in the condensation chamber by means of condensation on the condensation surface; and
a water holding and/or filtration arrangement which is in fluid communication with the condensation chamber, the water holding and/or filtration arrangement being configured to receive the extracted water from the condensation chamber and to hold and/or filter the extracted water.

2. An atmospheric water generator as claimed in claim 1, wherein the evaporator is located inside of the coolant container; and wherein the coolant container is sealed.

3. (canceled)

4. An atmospheric water generator as claimed in claim 1, wherein the evaporator is an evaporator array.

5. An atmospheric water generator as claimed in claim 1, wherein the coolant is a liquid substance.

6. (canceled)

7. An atmospheric water generator as claimed in claim 1, wherein the atmospheric water generator further comprises a pump for circulating the coolant in a loop through the coolant container, where it is cooled, through the condensation arrangement, where it becomes warmer as a result of heat exchange with the air, and back through the coolant container for re-cooling.

8. An atmospheric water generator as claimed in claim 1, wherein the at least one condensation surface is defined by at least one condensation plate.

9. An atmospheric water generator as claimed in claim 8, wherein the condensation plate is substantially disc-shaped.

10. An atmospheric water generator as claimed in claim 8, wherein the condensation plate defines an internal flow path through which the coolant operatively flows to cool the condensation surface(s).

11. An atmospheric water generator as claimed in claim 8, wherein the at least one condensation surface is provided with surface roughness, texturing and/or deformations.

12. An atmospheric water generator as claimed in claim 11, wherein the condensation surface is engraved with pit formations.

13. An atmospheric water generator as claimed claim 8, wherein the condensation chamber houses a condensation plate assembly which includes a plurality of vertically spaced apart condensation plates.

14. An atmospheric water generator as claimed in claim 13, wherein the condensation arrangement further comprises a discharge manifold and a suction manifold, wherein the discharge manifold comprises a primary single pipe structure, in fluid communication with the coolant container, which is configured to receive the coolant from the coolant container and which defines multiple branches of secondary pipelines configured to distribute the coolant into the respective condensation plates.

15-16. (canceled)

17. An atmospheric water generator as claimed in claim 1, wherein the condensation arrangement further comprises at least one fan for producing air flow in the condensation chamber, wherein the at least one fan is configured to produce air flow in a direction substantially parallel to the at least one condensation surface.

18. (canceled)

19. An atmospheric water generator as claimed in claim 1, wherein the condensation chamber is defined by an enclosure.

20. An atmospheric water generator as claimed in claim 19, wherein the enclosure comprises at least one vent which is positioned so as operatively to increase internal static pressure in the condensation chamber.

21-23. (canceled)

24. An atmospheric water generator as claimed in claim 1, wherein the condensation arrangement further comprises at least one wiper arm which is configured to sweep or be dragged across the at least one condensation surface at predetermined intervals, thereby facilitating collection of condensation from the condensation surface.

25. An atmospheric water generator as claimed in claim 24, wherein the condensation arrangement further comprises a rotatable shaft which is configured to rotate the at least one wiper arm about or along the condensation surface.

26-31. (canceled)

32. An atmospheric water generator as claimed in claim 24, wherein the wiper arm is configured to sweep or be dragged across the at least one condensation surface at predetermined time intervals to allow water droplets to condense on the at least one condensation surface.

33. An atmospheric water generator as claimed in claim 33, wherein the predetermined time intervals are based on a five parameter logistic (5PL) asymmetrical sigmoidal model.

34. A process for extracting water from air, the process comprising:
cooling a coolant by means of heat exchange between the coolant and a refrigerant circulating through a vapour-compression system; and
using the coolant to cool at least one condensation surface housed in a condensation chamber external to the vapour-compression system, thereby to extract water from air in the condensation chamber by means of condensation on the condensation surface.

35-42. (canceled)
